(19) United States
(12) Patent Application Publication
(10) Pub. No.: US 2019/0053495 A1
(43) Pub. Date: Feb. 21, 2019

(54) POLYMERIC TOPICAL ANTISEPTIC COMPOUND AND METHOD OF USE

(71) Applicants: Bruce Smyth, Byron Bay (AU); Michael Bralkowski, Lexington, NC (US)

(72) Inventors: Bruce Smyth, Byron Bay (AU); Michael Bralkowski, Lexington, NC (US)

(21) Appl. No.: 16/104,917

(22) Filed: Aug. 19, 2018

Related U.S. Application Data
(60) Provisional application No. 62/547,846, filed on Aug. 20, 2017.

(51) Int. Cl. A01N 55/02; A01N 33/04; A01N 25/02; A01N 25/04

(52) U.S. Cl. CPC A01N 55/02; A01N 25/04; A01N 25/02; A01N 33/04

(57) ABSTRACT

Topical antiseptic rubs are disclosed that reduce microorganism loading on the skin surface preventing possible infections. The FDA currently recognizes ethanol, isopropanol and benzalkonium chloride as active ingredients but further defines the actives as chronic use drugs. The present invention describes formulations and applications of a liquid compound that forms a topical polymeric skin layer consisting of a given benzalkonium chloride concentration within the matrix, which quickly reduces all bacteria including the MERS, virus types, and kills spores including the Clostridium difficile. The “second skin” concept, is likened to the human skin cellular function of the stratum corneum, functions as a barrier to exogenous substances, which reduces any chronic flux of benzalkonium chloride into the epidermis and reducing symptoms of constant usage. The second skin polymeric application agglomerates, traps and kills bacteria. The “second skin” provides for cosmetic moisturizing, barrier effects and skin softness.

This application claims the priority benefit under 35 U.S.C. section 119 of U.S. Provisional Patent Application No. 62/547,846 entitled “Polymeric Topical Antiseptic Compound And Method Of Use” filed on Aug. 20, 2018; and which is in its entirety herein incorporated by reference.

### FIELD OF THE INVENTION

The present invention provides for novel compounded formulations that are considered topical antiseptic compositions as defined by the US Federal Drug Administration (FDA) with the listed nomenclature of “consumer antiseptic rubs” (Federal Register/Vol 81. No 243/Wednesday, Dec. 20, 2017 Food and Drug Administration 21 CRF Part 310 Safety and Effectiveness of Health Care Antiseptics: Topical Antimicrobial Drug Products for Over-The-Counter Human Use), “health care worker's antiseptic rubs” (Federal Register/Vol 82. No 243/Wednesday, Dec. 20, 2017 Food and Drug Administration 21 CRF Part 310 Safety and Effectiveness of Health Care Antiseptics: Topical Antimicrobial Drug Products for Over-The-Counter Human Use), “topical antiseptics”, “surgical scrubs” and “first aid antiseptics” to include topical sanitizing wipes for bathing, pre/post surgery, barrier and general topical sanitizing of the skin.

Since the active compound in the formulations are antimicrobials by definition and prescribed in the formulations at concentrations adequate to do damage to bacterial cells or viral structures, the FDA has had concern of the effects of actives as a “chronic drug” absorbed by the skin over a six months period. To reduce the FDA concerns of over-absorption by fluxing the active into the skin, the invention uses a monomer film forming compound to polymerize on top the skin and thus maintain the active on top of the skin.

The invention provides formulations which includes the delivery of a cationic, polymeric film former which upon contacting the skin, at room and body temperature, initiates a condensation polymerization reaction with the evaporation of the carrier water. As the reaction nears completion the incorporated biocidal actives are within the matrix and affect the skin flora. The reaction provides a method to trap and hold the actives on the surface of the skin while performing the FDA requirements of an antiseptic rub by killing microorganisms. The film former eliminates chronic effects upon and within the skin through reduction of biocidal active's flux into or through the skin.

The compounded formulations also provide for the unique architectural structure of the film former and actives upon the skin as developed to provide polymerized cationic peaks connected by higher molecular weight polymeric dense throughs all in the nanometer size.

The compounded formulations also provide for a solution in which Benzalkonium halides and Chlorhexidine gluconate formulations in the market having been exposed to Burkholderia cepacia biofilms can be compromised and do not kill Burkholderia cepacia but actually grow Burkholderia cepacia in the contained fluid or wipe.

The compounded formulations can be administered in a convenient manner in foamer bottles, spray bottles, gel tubes, bath wipes, hand wipes, solid films and solid sol-gel films.

The compounded formulations are not flammable as are the active alcohols so no special storage conditions are needed.

There is a long felt need in the art for anti-microbial compositions that are used to rub into the hands and retain their activity by forming a film that retains the active.

### BACKGROUND OF THE INVENTION

There is a continued need for contact protection from micro-organisms such as bacteria, virus, fungi and single cell organisms. It is evident as the infectious diseases agencies reported increases in outbreaks and incidents.

The human body has inherent immune system mechanisms to affect microorganisms but remains genetically susceptible to microorganism attack. There is the subsequent ability to transfer bacteria, virus and fungus by contact to other humans. Since microorganism are part of the skin biome and nosocomial microorganisms are found in aerosols, fomites, infected wounds and tissues, and hard surfaces, a safe, fast killing and persistent topical antiseptic treatment such as a rub or scrub or ointment is needed. With the safety concern issues of ethanol and isopropanol as a chronic drug for health care workers, the invention provides a lower concentration of biocides trapped on top of the skin as a means to continue a healthy treatment of sanitization.

The Center for Disease Control (CDC) estimates that more than two million people are affected by antibiotic-resistant infections every year in the United States, with at least 23,000 dying as a result. Hospital nosocomial infections have generated the terms methicillin resistant Staphylococcus aureus (MRSA), vancomycin resistant Enterococcus (VRE), carbapenem-resistant Enterobacteriaceae (CRE), multi-drug resistant tuberculosis (MRT TB) and Clostridium difficile (C Dif) as a listing for infections caused by bacteria which have mutated to become resistant to common antibiotics. The crisis has accelerated due to Horizontal Gene Transfer within bacterial environments to evolve and developing R genes which have become resistant to antibiotics. The term “superbugs” refers to microbes with enhanced morbidity and mortality due to multiple mutations endowing high levels of resistance to the antibiotic classes specifically recommended for their treatment. The therapeutic options for these microbes are reduced, and periods of hospital care are extended and costly. In some cases, super resistant strains have also acquired increased virulence and enhanced transmissibility.

While microorganisms are transferred by contact, hand washing and effective hand sanitization remain as a visible means to reduce the spread of microorganisms, especially antibiotic resistant microorganisms

The FDA considers antimicrobial topical antiseptics a drug and further allows the industry to produce protection under an Over the Counter Drug tentative monograph listed in 1984 under and in FDA 2016-N-0124. In 2015 and 2016, the FDA proposed final OTC Drug Monographs which defined consumer antiseptic rubs and separately the health care worker antiseptic rubs. To further clarity, FDA defines “Rubs” as typical leave on products referring to their antimicrobial properties that are not rinsed off the skin like soap and water in a hand wash. The FDA infers that the chemistry of the rubs will either stay on the stratum corneum or flux into the epidermis, dermis or microcapillaries within the skin. The chemistry is dangerous enough to be antimicrobial or bactericidal therefore killing microorganisms such as bacteria or germs, while not destructive to human tissue, cells, human DNA or general health of the user.

The FDA also contends that “the consumer antiseptic rubs are intended to provide immediate reduction of bacteria rather than a persistent benefit”. The topical antiseptic compositions comprise of a FDA currently approved active compounds or bactericidal compounds such as Benzalkonium chloride, ethanol and isopropanol as listed in the 21CFR part 310.

The present invention provides for compositions using the active Benzalkonium chloride at concentration limits prescribed and listed in the Federal Register at 0.10-0.13% wt range. There is also a need for a non-alcohol topical rubs which kills most major pathogens in a quick and efficacious manner defined by the FDA while not acting as a chronic drug.

In U.S. Pat. No. 7,754,770 Antimicrobial Compositions, Curtis teaches that a compounded formulation with 1000-1200 ppm N,N dimethyl alkylamine homologs of C₁₂ and C₁₄ as an active and foaming agents such as dihydroxypropyl PEG 15 linoleammonium chloride and stabilizers and emollients of ammonium lactate is effective against bacteria in a time kill dilution test and determined acute toxicity data in animal testing using Benzalkonium chloride as an active at 0.1%. However, at 2 g/kg of Benzalkonium chloride as applied uniformly to an area of 10% of shaven skin on all ten test animals; all test animals exhibit erythema, and edema at the application site on Study Day 1.

As stated by the FDA, “Many of the safety considerations for consumer antiseptic rubs are based on FDA's view that the use of consumer antiseptic rubs is a “chronic” use as that term is defined by the International Council on Harmonization (ICH). As defined by the ICH, a use is considered chronic if the drug will be used for a period of at least 6 months over the user's lifetime, including repeated, intermittent use. We believe that consumer antiseptic rubs are often used on a daily basis and sometimes repeatedly over the course of the day. Usages by health care workers could be seen to up to 100 applications per day.

Because of advances in technology, our ability to detect antiseptic active ingredients in body fluids such as serum and urine is greater than it was in 1994. For example, studies have shown detectable blood alcohol levels after use of alcohol containing hand rubs we believe that any consequences of this systemic exposure should be identified and assessed to support our risk-benefit analysis for consumer antiseptic use. Given the frequent repeated use of consumer antiseptic rubs, systemic exposure may occur. Although some systemic exposure data exist for all of the three consumer antiseptic rub active ingredients, data on systemic absorption after maximal use are lacking. Currently, there is also a lack of data to assess the impact of important drug use factors that can influence systemic exposure such as dose, application frequency and method, duration of exposure, product formulation, skin condition, and age.”

In U.S. Pat. No. 6,613,755 Peterson et al states that an 18% ethyl alcohol and trimethoxysilylpropyl dimethyloctadecyl ammonium chloride as a drug provides a hand sanitizer for the skin. No mention of the addition of other actives to disrupt the bacteria remaining on the treated skin nor be in compliance with FDA OTC Monographs.

In PCT/AU2015/050111, Bralkowski et al teach that the use of the film forming trimethoxysilypropyl dimethyl octadecyl ammonium chloride monomer from 0.1 to 1.5% wt combined with benzalkonium chloride to be an effective hand sanitizer. No mention is made to formation of a skin scaffold or second skin which is effective in encapsulating Clostridium difficle spores found on the human skin and furthermore no mention of an expanded range of the amount of trimethoxysilypropyl dimethyl octadecyl ammonium chloride monomer in excess of 1.5% wt can be used safely to further the benefits of the hand rub.

In US 2006/0193816 A Elfersey et al states that mixtures of organosilane quaternaries and quaternary ammonium chloride with hydrogen peroxide and nonyl phenol ethoxylates are suitable compositions of biocidal treatments effective against bacterial spores. However, Elfersey could not use on the skin to kill spores due to the unapproved ingredients in the quaternium mixture since only Benzalkonium chloride and Benzethonium chloride (tentatively) are approved for human skin contact. Nonyl phenol ethoxylates are endocrine disruptors.

In WO 2011/123623A3 Higgins and Bralkowski claim methyl anthranilate and silane quaternary extend protection for 24 hours at 0.9% silane quat. The patent does not teach of ability to kill spores.

In US 2014/0011766 A1 Kraft teaches of an antimicrobial composition and hand sanitizing composition which disinfects precleaned hard surfaces by killing 99.99 percent of germs, including turberculosis, MRSA, VRE and viruses. The compound contains: ethanol 50.0-80.0 percent by weight; and a treated particle with an antimicrobial organosilane compound attached to it 0.01-5.0 percent by weight the treated particle is a powder chosen from the group consisting of Zinc oxide, silica, calcium carbonate, and talc. Kraft doesn't mention the effects of the compound on spores or molds. Nor does he teach of the use of Polyhexanide as a Pseudomonas aeruginosa biocide. Nor does his composition contain surfactants to clean surfaces.

U.S. Pat. Nos. 5,827,870 and 5,661,170, to Chodosh, discloses an antimicrobial “SAB” composition that treats microbial infections. The antimicrobial composition includes a quaternary ammonium compound in an aqueous solution, Wherein the preferred quaternary ammonium compound is benzalkonium chloride (BZK). The antimicrobial composition also contains a surfactant and the keratolytic agent allantoin (SAB) surfactant, allantoin, and BZK). The composition disclosed is solely antimicrobial in nature and is ideally suited for subcutaneous, cutaneous, or mucosal membrane administration.

US 2015/0045443 A1 to Weaver teaches the use of multiple quaternium compounds in water and acidified with concentrated mineral acids. Weaver does not refer to use of polymeric Polyhexanide or other polymerics to adjust the film former structure.

In U.S. Pat. No. 5,902,820 Jacquess et al describes the use of Propiconazole and Dodecylamine or a dodecylamine salt for controlling the growth of microorganisms especially fungal microorganisms. Jacques does not teach the use with 1-octadecanaminium-N,N-dimethyl-N-[(3-triethoxysilyl)propyl]chloride.

It is well known that spore germination can be controlled by certain environmental and chemical stimulants such as high pressure, high temperatures and certain amine chemistries. Luo Mi et al in Chemical Insights into Dodecylamine Spore Lethal Germination state that dodecylamine may change the osmoregulatory function of the spore cortex thereby allowing dipiconlinic acid and water to transfer between the core. Luo doesn't declare that the use of other compound which support the addition of Dodecylamine provide for better microorganism control in a hand sanitizer that encapsulates spores in a polymer.

U.S. Pat. No. 6,503,952 of Modak et al discloses a triple antimicrobial composition having chlorhexidine (or a salt 2 thereof), a quaternary ammonium compound such as BZK, and a chlorinated phenol compound such as para chlorometaxylenol. Optionally alcohol may be included. This composition is stated to be antimicrobial, but it is silent with respect to reducing or controlling viruses. The prior art has disadvantages. The prior art fails to reduce, control or eliminate certain viruses especially the norovirus (the cruise ship virus) and other similar viruses.

U.S. Pat. No. 8,383,164 B2 to Cueman et al teaches an alcohol-free antiviral composition that includes between about 0.1 to about 3 wt % of hydrogen peroxide, between about 0.1 to about 0.3 wt % of an benzalkonium chloride, between about 0.1 to 1 wt % of a parachlorometaxylenol, and at least about 60 wt % aqueous solvent.

US 2013/0017242 A1 Richardson et al teach that a wipe can be made of a flexible absorbent substrate comprising natural material and a solution impregnated into said substrate with said solution containing an organo-functional silane-base quaternary ammonium salt at a concentration of between about 0.10 percent to 2.0 percent in water for antimicrobial protection. Richardson does not teach that cotton or most natural fibers have a problem with the organosilanes covalently bonding to the said natural fibers and becoming ineffective at controlling microorganisms on the surface that would be treated with the wipe. Peterson refers to this in U.S. Pat. No. 6,613,755.

There is a need for a hand sanitizer and methods to apply the hand sanitizer that is nontoxic and does not irritate the skin after frequent, long term use and is alcohol-free.

### SUMMARY OF THE INVENTION

The invention provides a composition for use on mammals as a topical antiseptic rub, said composition comprising: (a) a polymeric skin scaffold selected from the group consisting of: polymers of 1-Octadecanaminium N,N dimethyl [(3-trihdroxysilyl) propyl] chloride, silk protein, polyhexanide and mixtures thereof; said skin scaffold further including a monomeric coupling agent selected from the group consisting of of alkyl dialkylammonium trimethoxysilyl propyl chloride; (b) an antimicrobial active selected from the group consisting of alkyldimethylbenzylammonium chloride of the formula

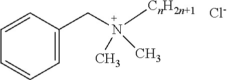

where n=8, 10, 12, 14, 16, 18; (c) a carrier for the polymers consisting of pharmaceutical grade water and surfactants selected from the group consisting of non-ionics, anionic, cationic, amphoteric and switterionic surfactants said surfactants also being suitable for emulsification of the composition; and (d) a clay stabilizer for the trimethoxysilyl functional group.

The invention also provides a composition for use on mammals as a topical antiseptic rub, said composition comprising: (a) a polymeric skin scaffold selected from the group consisting of: polymers of 1-Octadecanaminium N,N dimethyl [(3-trihdroxysilyl) propyl] chloride, silk protein, polyhexanide and mixtures thereof; said skin scaffold further including a monomeric coupling agent selected from the group consisting of of alkyl dialkylammonium trimethoxysilyl propyl chloride; and (b) an extracellular matrix comprising hyaluronic acid and sodium salts thereof.

### BRIEF DESCRIPTION OF THE FIGURES

FIG. 1 shows Bacillus spores evenly distributed in a slide.

FIG. 2 illustrates addition of the hand sanitizer with 1.6 wt % ODTMSPC active showing agglomerated spores and encapsulation.

FIG. 3 shows the Bacillus spores from FIG. 1 with hand sanitizer ODTMSPC at 1.6 wt % after 2 hours dried as water evaporated. The spores are encapsulated in ODTMSPC polymer film.

### DETAILED DESCRIPTION OF THE INVENTION

### Definitions

Unless defined otherwise, all technical and scientific terms used herein have the same meaning as commonly understood by those of ordinary skill in the art to which the invention belongs. Although any methods and materials similar or equivalent to those described herein can be used in the practice or testing of the present invention, preferred methods and materials are described. For the purposes of the present invention, the following terms are defined below.

As used herein, the term “alkyl” refers to a straight chain or branched saturated hydrocarbon group having 1 to 22 carbon atoms. Where appropriate, the alkyl group may have a specified number of carbon atoms, for example, C_{1-6alkyl} which includes alkyl groups having 1, 2, 3, 4, 5 or 6 carbon atoms in a linear or branched arrangement. Examples of suitable alkyl groups include, but are not limited to, methyl, ethyl, n-propyl, s′-propyl, n-butyl, s′-butyl, i-butyl, n-pentyl, 2-methylbutyl, 3-methylbutyl, 4-methylbutyl, n-hexyl, 2-methylpentyl, 3-methylpentyl, 4-methylpentyl, 5-methylpentyl, 2-ethylbutyl, 3-ethylbutyl, heptyl, octyl, nonyl, decyl, isodecyl, undecyl, dodecyl and the like.

As used herein, the term “cycloalkyl” refers to a saturated cyclic hydrocarbon. The cycloalkyl ring may include a specified number of carbon atoms. For example, a 3 to 8 membered cycloalkyl group includes 3, 4, 5, 6, 7 or 8 carbon atoms. Examples of suitable cycloalkyl groups include, but are not limited to, cyclopropyl, cyclobutyl, cyclopentyl, cyclohexyl, cycloheptyl and cyclooctyl.

As used herein, the term “aryl” is intended to mean any stable, monocyclic, bicyclic or tricyclic carbon ring system of up to 7 atoms in each ring, wherein at least one ring is aromatic. Examples of such aryl groups include, but are not limited to, phenyl, naphthyl, tetrahydronaphthyl, indanyl, fluorenyl, anthracenyl, phenanthrenyl, biphenyl and binaphthyl.

As used herein, the term “alkylene” refers to a divalent saturated hydrocarbon chain having 1 to 6 carbon atoms. Where appropriate, the alkylene group may have a specified number of carbon atoms, for example, C₁₋₆ alkylene includes alkylene groups having 1, 2, 3, 4, 5 or 6 carbon atoms in a linear arrangement. Examples of suitable alkylene groups include, but are not limited to, —CH₂—, —CH₂CH₂—, —CH₂CH₂CH₂—, —CH₂CH₂CH₂CH₂—, —CH₂CH₂CH₂CH₂CH₂— and —CH₂CH₂CH₂CH₂CH₂CH₂—.

The term “heterocyclic” or “heterocyclyl” as used herein, refers to a cyclic hydrocarbon in which one to four carbon atoms have been replaced by heteroatoms independently selected from the group consisting of N, N(R), S, S(O), S(0)₂ and O. A heterocyclic ring may be saturated or unsaturated but not aromatic. A heterocyclic group may also be part of a spirocyclic group containing 1, 2 or 3 rings, two of which are in a “spiro” arrangement. Examples of suitable heterocyclyl groups include azetidine, tetrahydrofuranyl, tetrahydrothiophenyl, pyrrolidinyl, 2-oxopyrrolidinyl, pyrrolinyl, pyranyl, dioxolanyl, piperidinyl, 2-oxopiperidinyl, pyrazolinyl, imidazolinyl, thiazolinyl, dithiolyl, oxathiolyl, dioxanyl, dioxinyl, dioxazolyl, oxathiozolyl, oxazolonyl, piperazinyl, morpholino, thiomorpholinyl, 3-oxomorpholinyl, dithianyl, trithianyl and oxazinyl.

The term “heteroaryl” as used herein, represents a stable monocyclic, bicyclic or tricyclic ring of up to 7 atoms in each ring, wherein at least one ring is aromatic and at least one ring contains from 1 to 4 heteroatoms selected from the group consisting of O, N and S. Heteroaryl groups within the scope of this definition include, but are not limited to, acridinyl, carbazolyl, cinnolinyl, quinoxalinyl, quinazolinyl, pyrazolyl, indolyl, isoindolyl, 1H,3H-1-oxoisoindolyl, benzotriazolyl, furanyl, thienyl, thiophenyl, benzothienyl, benzofuranyl, benzodioxane, benzodioxin, quinolinyl, isoquinolinyl, oxazolyl, isoxazolyl, imidazolyl, pyrazinyl, pyridazinyl, pyridinyl, pyrimidinyl, pyrrolyl, tetrahydroquinolinyl, thiazolyl, isothiazolyl, 1,2,3-triazolyl, 1,2,4-triazolyl, 1,2,4-oxadiazolyl, 1,2,4-thiadiazolyl, 1,3,5-triazinyl, 1,2,4-triazinyl, 1,2,4,5-tetrazinyl and tetrazolyl. Particular heteroaryl groups have 5- or 6-membered rings, such as pyrazolyl, furanyl, thienyl, oxazolyl, indolyl, isoindolyl, 1H,3H-1-oxoisoindolyl, isoxazolyl, imidazolyl, pyrazinyl, pyridazinyl, pyridinyl, pyrimidinyl, pyrrolyl, thiazolyl, isothiazolyl, 1,2,3-triazolyl, 1,2,4-triazolyl and 1,2,4-oxadiazolyl and 1,2,4-thiadiazolyl.

Alkyl, cycloalkyl, heterocyclyl, heteroaryl and aryl groups of the invention may be optionally substituted with 1 to 5 groups selected from OH, O C₁₋₆alkyl, CI, Br, F, I, NH₂, NH(C₁₋₆alkyl), N(C₁₋₆alkyl)₂, SH, S C₁₋₆alkyl, CO₂H, C0₂C₁₋₆ alkyl, CONH₂, CONH(C₁₋₆ alkyl) or CON(C₁₋₆alkyl)₂.

As used herein, the term “divalent bridging group” refers to a radical that has a valence of two and is able to bind with two other groups. Examples of suitable divalent bridging groups include but are not limited to —(CH₂)ₜ— where t is an integer from 1 to 10, -0-, —S—, a divalent saturated or aromatic carbocyclic ring or a heterocyclic or heteroaromatic ring or a combination of such divalent and/or cyclic moieties. For example a saturated C₆ cyclic group would include —C₆H₁₁—, a C₆aromatic group would include —C₆H₄—, a C₆ heterocyclic group would include

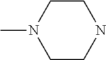

and a C₆ heteroaromatic would include

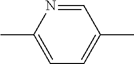

Other divalent bridging groups include alkylene groups (—CH₂-)ₜ in which one or more carbon atoms have been replaced by NH, S, O,

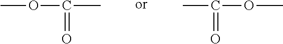

In a preferred embodiment the divalent bridging group is —(CH₂)ₜ— where t is an integer from 1 to 10, especially 1 to 6, more especially 3 to 6.

The compounds of the invention may be in the form of pharmaceutically acceptable salts. It will be appreciated however that non-pharmaceutically acceptable salts also fall within the scope of the invention since these may be useful as intermediates in the preparation of pharmaceutically acceptable salts or may be useful during storage or transport. Suitable pharmaceutically acceptable salts include, but are not limited to, salts of pharmaceutically acceptable inorganic acids such as hydrochloric, sulphuric, phosphoric, nitric, carbonic, boric, sulfamic, and hydrobromic acids, or salts of pharmaceutically acceptable organic acids such as acetic, propionic, butyric, tartaric, maleic, hydroxymaleic, fumaric, maleic, citric, lactic, mucic, gluconic, benzoic, succinic, oxalic, phenylacetic, gallic methanesulphonic, toluenesulphonic, benezenesulphonic, salicylic sulphanilic, aspartic, glutamic, edetic, stearic, palmitic, oleic, lauric, pantothenic, tannic, ascorbic and valeric acids.

### Polymeric Compositions

In a first aspect of the present invention, there is provided a carrier for the bactericidal active which comprises a water soluble liquid monomer and water soluble polymer compounds which when activated will through condensation polymerization at room temperature react to form a polymeric film skin or skin scaffold or biomimetic.

According to Zhong, “engineering skin substitutes by tissue engineering approach has relied upon the creation of three-dimensional scaffolds as extracellular matrix (ECM) analog to guide cell adhesion, growth, and differentiation to form skin-functional and structural tissue. The three-dimensional scaffolds can not only cover wound and give a physical barrier against external infection as wound dressing, but also can provide support both for dermal fibroblasts and the overlying keratinocytes for skin tissue engineering. A successful tissue scaffold should exhibit appropriate physical and mechanical characteristics and provide an appropriate surface chemistry and nano and microstructures to facilitate cellular attachment, proliferation, and differentiation. Highlighted emerging fabrication technique is electrospinning that allows the design and fabrication of biomimetic scaffolds that offer tremendous potential applications in wound healing of skin.”

The invention provides compositions containing: (i) an alkoxy silyl ammonium compound monomer; (ii) an alkoxy silyl ammonium compound polymer; (iii) a polymeric biguanide; (iv) a polymeric stabilizer such as a smectite, bentonite or filler such as hydroxyethyl cellulose; (v) a natural silk fibroin and (vi) multiple oxirane polymeric surfactants.

In some embodiments, the alkoxy silyl ammonium polymer and monomer combination film-forming agents is an alkoxy silyl quaternary ammonium film forming agent. Alkoxy silyl quaternary ammonium film forming agents are also known in the art as organosilicon quaternary ammonium film forming compounds.

In some embodiments, the alkoxy silyl ammonium film-forming agent is a compound of formula:

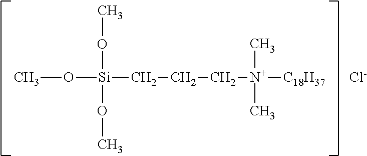

Other film forming agents include compounds corresponding to the following formula

R₁,R₂,R₃—Si—CH₂CH₂CH₂—N⁺—R_{Y}R_{X}R_{Z}W⁻

wherein W⁻ is a Cl, Br; F or I, more in particular Cl⁻, R₁, R₂, R₃ are CH₃O— or CH₃CH₂O— groups. In particular embodiments, one or more of the following maybe suitable R₁, R₂, R₃ which are selected from a hydrogen, hydroxy, alkoxy such as methoxy or ethoxy, alkyl such as methyl or ethyl; R_{Y} is a C₁-C₅ alkyl group preferably a CH₃ group; and R_{X} is C₁-C₅ alkyl group preferably a CH₃ group; and R_{Z} is a C₇-C₁₈ alkyl or a mixture of various alkyl species but predominately C₁₈ alkyl or C₁₂ alkyl or both, more particularly C₁₈ alkyl.

In particular embodiments, the alkoxy silyl ammonium film-forming compounds of formula are selected from 1-octadecanaminium-N,N-dimethyl-N-[(3-trimethoxysilyl)propyl]-chloride, 1-octadecanaminium-N,N-dimethyl-N-[(3-triethoxysilyl)propyl]chloride, and 1-octa-decanaminium-N,N-dimethyl-N-[(3-trihydroxysilyl)propyl]chloride, 3-trimethoxysilylpropyl-N,N-dimethyl-N-octadecyl ammonium chloride), 3-triethoxysilylpropyl-N,N-dimethyl-N-octadecyl ammonium chloride, 3-trimethoxysilyl propyl-N,N-dimethyl-N-octyl ammonium chloride, 3-triethoxysilylpropyl-N,N-dimethyl-N-octyl ammonium chloride, 3-triethoxysilylpropyl-N,N-dimethyl-N-isodecyl ammonium chloride, 3-trimethoxysilylpropyl-N,N-dimethyl-N-isodecyl ammonium chloride, 3-trimethyoxysilylpropyl-N,N-dimethyl-N-decyl ammonium chloride, 3-tri-ethyloxysilylpropyl-N,N-dimethyl-N-decyl ammonium chloride, 3-trimethyoxysilylpropyl-N,N-dimethyl-N-dodecyl ammonium chloride, 3-triethyloxysilylpropyl-N,N-dimethyl-N-dodecyl ammonium chloride, 3-trimethoxysilylpropyl-N,N-dimethyl-N-tetradecyl ammonium chloride, 3-triethoxysilylpropyl-N,N-dimethyl-N-tetradecyl ammonium chloride, 3-trimethoxysilylpropyl-N,N-dimethyl-N-hexadecyl ammonium chloride, 3-triethoxysilylpropyl-N,N-dimethyl-N-hexa-decylammonium chloride, 3-trimethoxysilylpropyl-N,N-dimethyl-N-octadecyl ammonium chloride, 3-triethoxysilylpropyl-N,N-dimethyl-N-octadecyl ammonium chloride, 3-trimethoxy-silylpropyl-N,N-dimethyl-N-docosyl ammonium chloride, 3-triethoxysilylpropyl-N,N-dimethyl-N-docosyl ammonium chloride, 3-trimethoxysilylpropyl-N,N-dimethyl-N-eicosyl ammonium chloride, 3-triethoxysilylpropyl-N,N-dimethyl-N-eicosyl ammonium chloride, 3-trimethoxy-silylpropyl-N,N-dimethyl-N—C₁₂-C₁₆ ammonium chloride, where C₁₂=65% and C₁₆=33%, 3-triethoxysilylpropyl-N,N-dimethyl-N—C₁₂-C₁₆ ammonium chloride, where C₁₂=65% and C₁₆=33%, 3-trimethoxysilylpropyl-N,N-dimethyl-N—C₁₆-C₂₂ ammonium chloride, where C₁₆=16% and C₂₂=83%, 3-triethoxysilylpropyl-N,N-dimethyl-N—C₁₆-C₂₂ ammonium chloride, where C₁₆=16% and C₂₂=83%, 3-trimethoxysilylpropyl-N,N-dimethyl-N—C₁₄-C₁₈ ammonium chloride, where C₁₄=4%, C₁₆=31% and C₁₈=64%, 3-triethoxysilylpropyl-N,N-dimethyl-N—C₁₄-C₁₈ ammonium chloride, where C₁₄=4%, C₁₆=31% and C₁₈=64%, 3-trimethoxysilylpropyl-N,N-dimethyl-N—C₁₂-C₁₆ ammonium chloride, where C₁₂=41%, C₁₄=50% and C₁₆=9%, 3-triethoxy-silylpropyl-N,N-dimethyl-N—C₁₂-C₁₆ ammonium chloride, where C₁₂=41%, C₁₄=50% and C₁₆=9%, 3-trimethoxysilylpropyl-N,N-dimethyl-N—C₁₂-C₁₈ ammonium chloride, where C₁₂=49%, C₁₄=20%, C₁₆=11% and C₁₈=10%, 3-triethoxysilylpropyl-N,N-dimethyl-N—C₁₂-C₁₈ ammonium chloride, where C₁₂=49%, C₁₄=20%, C₁₆=11% and C₁₈=10%.

The alkoxy silyl ammonium film-forming compound is present in the composition in an amount in the range of 0.1% to 5.0% w/w, particularly about 1.0% to 3.0% w/w, more particularly about 1.51 to 2.5% w/w of the active in the composition.

It is known that alkoxy silyl quaternary ammonium compounds hydrolyze in water forming the trihydroxy silicon functional group, therefore, for example, 3-trimethoxysilylpropyl-N,N-dimethyl N-octadecyl ammonium chloride is hydrolyzed to form 3-trihydroxy silylpropyl-N,N-dimethyl-N-octadecyl ammonium chloride. The alkyl silyl ammonium compound are made in ethanol or methanol as a solvent. There is 22% methanol in 1-octadecanaminium-N,N-dimethyl-N-[(3-trimethoxysilyl)propyl]chloride product and 22% ethanol is in 1-octadecanaminium-N,N-dimethyl-N-[(3-triethoxysilyl)propy]chloride.

The addition of the polymer 1-Octadecanaminimum N,N-Dimethyl N (3-trihydroxy-silyl)propyl chloride couples with the monomer forming high density sites upon drying (film forming) that are closer to the surface than the monomeric condensation polymeric reaction. The topography of the film formed becomes peaks and throughs.

The Polyhexanide salts for use in compositions according to the invention will typically be the protonated form of the following general formula;

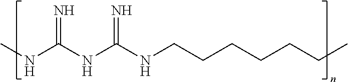

wherein n may have a value of up to about 500 or more, but typically has a value of 1-40, with termination of the polymer chain provided by an appropriate end group (see the Block reference described above). In preferred embodiments of the invention, n has an average value of 10-13; such a cosmetically acceptable Polyhexanide salt is the hydrochloride salt, which can be commercially obtained from Lonza under the trade name Vantocil P. Preferably, the Polyhexanide can be present in compositions according to the invention at a level of 0.01-0.5%, more preferably 0.2-0.1% by weight of the composition, though good results have been found with a level of 0.1-0.5% by weight of Polyhexanide salts in the composition.

In some embodiments, the polymeric biguanide is a compound of formula:

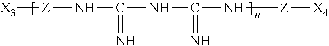

wherein Z is absent or an organic divalent bridging group and each Z may be the same or different throughout the polymer; n is at least 3, preferably 5 to 20 and X₃ and X₄ are independently selected from —NH₂, —NH—C(═NH)—NH—CN, optionally substituted alkyl, optionally substituted cyclo alkyl, optionally substituted aryl, optionally substituted heterocyclyl and optionally substituted heteroaryl; or a pharmaceutically acceptable salt thereof. Preferably, the molecular weight of the polymeric compound is at least 1,000 amu, more preferably between 1,000 amu and 50,000 amu. In a single composition, n may vary providing a mixture of polymeric biguanides.

The above polymeric biguanide compounds and methods for their preparation are described in, for example, U.S. Pat. No. 3,428,576 to East et. al.

The preferred monomeric species is of the formula

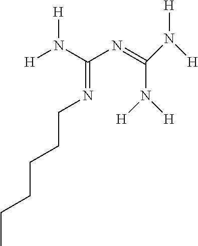

The polymeric biguanide is present in the composition in an amount in the range of 0.1% to 1.5% w/w, especially about 0.1% to about 1.0% w/w, more especially about 0.4% to about 0.6% w/w of the composition.

The polymeric biguanide is one of the most effective Pseudomonas aeruginosa biocides in water and active on biofilms of Pseudomonas. The Polyhexanide acts as a viable biocide and also as a water-soluble preservative for extended shelf life.

The silk protein (sericin and fibroin) are added to the polymer matrix for their ability to affect the film forming topographic properties of the silane monomer in providing a soft hand feel.

In some embodiments a stabilizer for the polymeric system is added to provide steric hindrance to the reactive trimethoxysilyl or trihydroxysilyl functional coupling groups. These stabilizer compounds are found to be smectite clays, montmorillonite, kaolin or bentonite clays, gums and sol gels. The water trapped within the clay matrix provides for a water bridge at the trihydroxysilyl stability and freeze point reduction.

In another aspect of the present invention, there is provided a suitable active antimicrobial or biocide that is compatible with a carrier to provide the bactericidal active. Benzalkonium chloride exists as a mixture of N,N-dimethyl alkyl amine homologs having the following structure. The benzalkonium antimicrobial agent can have the following structure:

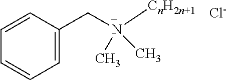

where n=8, 10, 12, 14, 16, 18.

Other quaternary ammonium salts that can be used correspond to the formula:

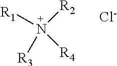

wherein R₁ is a benzyl group, R₂ is a C₂-C₂₂ alkyl group and R₃ and R₄ are methyl groups. In one embodiment, the benzalkonium chloride is USP grade, having not less than 40% C₁₂, not less than 20% C₁₄, and not less than 70% C₁₂ and C₁₄ homologs combined. In another embodiment, the combination of C₁₂ and C₁₄ homologs is less than 90%, less than 85%, less than 80%, or less than 75% combined C₁₂ and C₁₄ homologs. In a further embodiment, the homolog distribution is approximately 67% C₁₂, approximately 25% C₁₄, approximately 7% C₁₆ and approximately 1% C₁₈.

The benzalkonium chloride compound is present in an amount in the range of about 0.1% to 2.0% w/w of the composition, especially about 0.1% to about 0.5% w/w, more especially about 0.1% to 0.2% w/w of the composition, and even more especially about 0.1% to 0.13% w/w of the composition in accordance with regulations according to the Federal Drug Administration 21 CFR Parts 333 and 369—Tentative Final Monograph for Health-Care Antiseptic Drug.

In a noteworthy embodiment the monomeric/polymeric carrier and active possess a highly cationic charge or zeta potential that in water effects microorganisms that in turn have a negative or anionic charge. The concentrations of cationic actives allow for agglomeration of resident bacteria on the skin into packets of bacteria that are encapsulated and osmotically and electrochemical face cell lysis. This is extremely advantageous for Clostridium difficile spores contamination on skin.

The present invention provides a secondary carrier system of the active and film former polymer and monomer consisting of a surfactant system which emulsifies any oil to form an oil in water emulsion and wets and treats oil found on the skin during application. The surfactant package requires non-ionic or amphoteric or zwitterionic systems comprising an alcohol ethoxylate, an alkyl glucoside or alkyl polyglycoside and betaine

In particular embodiments, the alcohol ethoxylate is an alkyl alcohol ethoxylate, with HLB>9.0 for an oil in water emulsion; Biological activity in emulsions is found especially a C₁₂-C₁₈ alcohol ethoxylate and more especially a C₁₂₋₁₅ alcohol ethoxylate group. In particular embodiments, the alcohol ethoxylate comprises 6 to 16 ethoxylate groups, especially about 10 to 14 ethoxylate groups. An example of a useful alcohol ethoxylate are Pareth-9™, Laureth 4 or pentaerythritol ethoxylate also known as Polyol 4290.

The alcohol ethoxylate is present in the composition in an amount in the range of 0.1% to 2.0% w/w, especially 0.2 to 1.5% w/w, more especially about 0.5 to 1.0% w/w of the composition.

In particular embodiments, the alkylglucoside or alkylpolyglycoside is a C₈₋₁₆ alkylglucoside or alkylpolyglycoside, or a mixture thereof. In some embodiments, the alkylglucoside or alkylpolyglycoside is selected from caprylyl glucoside, caprylyl/capryl glucoside, octyl glucoside, decyl glucoside, dodecyl glucoside, coco glucoside, lauryl glucoside, caprylyl polyglycoside, caprylyl/capryl polyglycoside, decyl polyglycoside, dodecyl polyglycoside, coco polyglycoside and lauryl polyglycoside.

The alkyl glucoside or alkylpolyglycoside is present in the composition in an amount in the range of 0.3% to 1.5% w/w, especially about 0.5 to 1.0% w/w of the composition.

In some embodiments the surfactant system allows for skin oils such as to be micellized and absorbed into the polymeric condensation matrix while providing adherence of the polymer to skin squama.

In some embodiments the surfactant system is chosen due to its properties not to flux into the skin. In some embodiments, particularly those applications to skin, such as cracking hands or feet, the composition may further comprise a moisturizing, soothing, healing and antibacterial extract of aloe vera, citronella, PCB, Hyaluronic acid sodium salt, lanolin and amino acids such as arginine or lysine.

In some embodiments, the composition may also include other optional components such as dodecylamine and dodecylamine citrate as cationic components to germinate spores. The use of dodecylamine in 0.001 to 1.0 wt % is incorporated into the polymeric matrix of the 1-octadecanaminium-N,N-dimethyl-N-[(3-triethoxysilyl)propyl]chloride polymer.

In some embodiments, the composition may also include other optional components such as rheological modifiers, pH adjusters, lubricants, humectants, UV absorbers, fragrances and dyes. Suitable rheological modifiers include smectite clays, hydroxyethyl cellulose, hydroxypropyl cellulose and Carbapol. Suitable pH adjusters include buffers, acids and bases. For example, a suitable acidic adjuster is citric acid and a suitable basic adjuster is sodium hydroxide. Other suitable acidic adjusters include sorbic acid and lactic acid.

Suitable lubricants or humectants include, for example, glycerin or DEA. Fragrances include essential oils and synthetic fragrances to provide the desirable odor. Dyes or other coloring agents may also be included to impart a suitable color to the composition.

Non-limiting examples of preferred humectant type emollients include glycerol, polyglycerols (including: diglycerol, triglycerol, polyglycerin-3, tetraglycerol, hexaglycerol, decaglycerols) propylene glycol, dipropylene glycol, polypropylene glycol, polyethylene glycol (PEG-2 to PEG 45M, preferably a molecular weight between about 300 and 1,000), sorbitol, polyhydric alcohol ethoxylates (e.g. sorbeth 6, sorbeth-30, glycereth-1 to glycereth-31) methoxides of polyethylene glycol (Methoxy PEG-2 to Methoxy PEG-100) methoxides of polyhydric alcohol ethoxylates (e.g. glyc ereth-7 methoxide), pantothenol, gluconic acid salts and the like. Other humectant-type agents like that could also be employed include: 1,2,6-hexanetriol, acetamide MEA, aluminum hydroxide, arginine pea, butoxypropanol, butylene glycol, dimethyl imidazolidinone, dimethylsilanol hyaluronate, dipotassium glycyrrhizate, erythritol, ethoxy-diglycol, fructose, glucamine, gluconic acid, glucose, glucose glutamate, glucuronic acid, glutamic acid, glycogen, glycyrrhizic acid, heilmoor clay, hexacosyl glycol, hyaluronic acid, hydrogenated honey, hydrogenated starch, hydrolysate, hydrolyzed collagen, hydrolyzed elastin, hydrolyzed glycosaminoglycans, hydrolyzed keratin, hydrolyzed silk, hydrolyzed soy protein, hydrolyzed wheat protein, hydroxy ethyl sorbitol, inositol, inositol hexa-pea, lactamide MEA, lactic acid, lactitol, lactose, lysine pea, magnesium pea, maltitol, manganese pea, mannitol, mel (honey extract), menthyl pea, methyl gluceth-10, methyl gluceth-20, pea (pidolic acid), lactamide, polydextrose, polyglucuronic acid, polyglyceryl sorbitol, ppg-20 methyl glucose ether, PPG 38-buteth-37, saccharide isomerate, serica, silk amino acids, sodium carboxymethyl chitin, sodium lactate, sodium mannuronate methylsilanol, sodium PEA, sodium PEA methylsilanol, sodium polyglutamate, soluble collagen, sorbitol, sucrose, TEA-lactate, TEA-PEA, trehalose, trilactin, urea, xylitol, zea mays, zinc pea, and combinations thereof

In some embodiments, the compositions are aqueous compositions wherein the carrier comprises highly pure distilled water or demineralized water, especially where the carrier is water. Water with conductivity as low as possible to remove most minerals found in hard water. In some embodiments, the compositions of the invention can include alcohol such as ethanol or isopropanol as a component.

The compositions may conveniently be in the form of a liquid, gel, cream, foam or water soluble film. The water soluble film is the dried hydroxyethyl cellulose films dried at 180 F. The films can be wetted and applied to the skin. In some embodiments, the composition is impregnated in or coated on a textile to provide a wipe or sponge. In some embodiments, the composition is dispersed from a dispenser, such as a pump action dispenser, that dispenses a predetermined amount of composition. The compositions can be added to polyester non woven fabrics with high wet pick uptake to provide for a bath wipe, hand wipe, sponge wipe, or wound dressing.

The gel formulations have a viscosity in the temperature range of 5° C. to 50° C. in the range of from 5,000 to 60,000 mPa·s, especially about 16,000 to 50,000 mPa·s. The lower the ambient temperature, the greater the viscosity.

### Uses of the Sanitizing Compositions of the Invention

The topical antiseptic compositions of the present invention have antimicrobial activity that is useful in applications such as hand sanitation in food process plants, restaurants, operating rooms, hospitals, military base and field hospital units, laboratories, nursing homes, adult care centers, schools, child care facilities, sports facilities, dairy farms and livestock farms, banks, public transport facilities, cruise ships, shopping malls and other places where there is a risk of the spread of microbial infection, particularly patients in immune compromised floors in hospitals, the elderly in care and the young in child care cancer wards or cystic fibrosis wards. The compositions of the present invention may readily be used as an individual's hand sanitizers to kill pathogens on their hands and also to avoid spreading of infection. The hand sanitizers may be applied to the hands after a soap and water wash or where water and soap are not available in any suitable manner, for example, from a bottle foamer, a tube or pump action container, a wipe or sponge or in a spray from an electrostatic precipitator device.

The FDA proposes that a consumer antiseptic rub active ingredient be considered bactericidal at the concentration and contact time that demonstrates a 3-log 10 (99.9 percent) or greater reduction in bacterial viability for all the tested strains. This is the same performance criterion used by the Clinical and Laboratory Standards Institute (NCCLS, “Methods for Determining Bactericidal Activity of Antimicrobial Agents; Approved Guideline,” NCCLS document M26-A, 1999).

Inspections be measured after a single bacterial challenge, rather than after repeated contamination

The sanitizing composition is effective against a wide range of pathogens which are either killed or inactivated following application of the composition. Pathogens which are killed or inactivated by the sanitizing compositions of the present invention include:

Bacteroides fragilis, Enterobacter species, Burkholderia cepacia (ATCC 25416 and ATCC 25608), Escherichia coli (ATCC 11775 and ATCC 25922), Klebsiella pneumoniae (ATCC 13883 and ATCC 27736), Pseudomonas aeruginosa (ATCC 15442 and ATCC 27853), Serratia marcescens (ATCC 8100 and ATCC 14756), Campylobacter jejuni (ATCC 33291 and ATCC 49943), Salmonella enterica Serovar Enteritidis (ATCC 13076) and Serovar Typhimurium (ATCC 14028), where Serovar refers to the subspecies classification of a group of microorganisms based on cell surface antigens, Shigella sonnei (ATCC 9290 and ATCC 25931), Gram-positive organisms such as Enterococcus faecalis (ATCC 19433 and ATCC 29212), Staphylococcus aureus (ATCC 6538 and ATCC 29213) and methicillin-resistant Staphylococcus aureus (ATCC 33591 and ATCC 33592), Streptococcus pyogenes (ATCC 14289 and ATCC 19615), Listeria monocytogenes (ATCC 7644 and ATCC 19115), and Streptococcus pneumoniae (ATCC 6303 and ATCC 49619).

### Gram Positive Bacteria

Bacillus sp. (vegetative cell), Corynebacterium diptheriae, Clostridium difficile, Enterococcus faecalis, Enterococcus hirae, Listeria monocytogenes, Micrococcus luteus, Micrococcus sp., Mycobacterium tuberculosis, Mycobacterium smegmatis, Propionibacterium acnes, Staphylococcus aureus, Staphylococcus epidermidis, Staphylococcus haemolyticus, Staphylococus hominis, Staphylococcus saprophyticus, Streptococcus faecalis, Streptococcus mutans, Streptococcus pneumonia and Streptococcus pyogenes.

### Gram Negative Bacteria

Acinetobacter baumannii, Acinetobacter calcoaceticus, Aeromonas hydrophilia, Bacterioides fragilis, Burkholderia cepacia Citrobacter deversus, Citrobacter freundi, Enterobacter aerogenes, Enterobacter aglomerans, Enterobacter cloacae, Enterobacter gergoviae, Enterococcus, Escherichia coli, Escherichia coli 0157:H7, Eupenicillium levitum, Haemophilus influenza, Klebsiella oxytoca, Klebsiella pneumoniae, Klebsiella terriena, Legionella pneumophila, Morganella morganii, Penicillium luteum, Proteus mirabilis, Proteus vulgaris, Pseudomonas aeruginosa, Pseudomonas fluorscens, Salmonella cholera suis, Salmonella typhi, Salmonella typhimurium, Salmonella enterica, Serratia liquifaciens, Serratia marcescens and Xanthomonas campestris.

### Viruses

Adenovirus Type II & IV, Bovine Adenovirus Type I & IV, Murine Norovirus 1, Feline pneumonitis, Herpes Simplex Type I, Herpes Simplex Type II, HIV-1 (AIDS), Middle Eastern Respiratory Syndrome Virus (MERS), Influenza A2 (Aichi), Influenza A2 (Asian), Influenza B, Influenza (H1N1), Mumps, Parinfluenza (Sendai), Rous Sarcoma, Reovirus Type I, Simian Virus 40, Vaccinia, MS2 (bacteriophage), PRD1 (bacteriophage), Rhinoviruses and Enterovirus 71.

### Fungi, Algae, Mould, Yeast, Spores

Alterania alternata, Aphanizomenon sp., Aspergillus flavus, Aspergillus niger, Aspergillus sydowii, Aspergillus terreus, Aspergillus versicolor, Aspergillus verrucaria, Aureobasidium pullans, Candida albicans, Candida pseudotropocalis, Chaetomium globsum, Cladosporium cladosporioides, Chlorella vulgaris, Dreschslera australiensis, Epidermophyton sp., Epidermophyton floccosum, Gliomastix cerealis, Gloeophyllum trabeum, Microsporum sp., Microsporum audouinii, Monilia grisea, Oscillatoria, Penicillium chrysogenum, Pencillium commune, Penicillium funiculosum, Penicillium pinophilium, Penicillium variable, Phoma fimeti, Pithomyces chartarum, Poria placenta, Scenedesmus, Saccharonyces cerevisiae, Scolecobasidium humicola, Selenastrum sp., Trichoderma viride, Trichophyton interdigitale, Trichophyton maidson, Trichophyton mentogrophytes, Trichophyton rubrum and Trichophyton sp.

### Protozoa Parasites

Cryptosporidium parvum (oocysts).

The following examples are intended to demonstrate the usefulness of preferred embodiments of the present invention and should not be considered to limit its scope or applicability in any way.

### Example 1

My Shield—Unscented Antimicrobial Liquid Formulations with Aloe Vera

Several formulations were compounded as prepared with the following components as shown in Table 1 below:

TABLE 1

| | Formula | Formula | Formula | Formula | Formula |
|---|---|---|---|---|---|
| | No. 1 | No. 2 | No. 3 | No. 4 | No. 5 |
| CHEMICAL | Wt % | Wt % | Wt % | Wt % | Wt % |
| DI Water | 94.91 | 94.66 | 93.919 | 94.66 | 94.659 |
| ODTMSPC¹ | 2.2 | 2.2 | 2.2 | — | — |
| ODTHSPCP² | 0.01 | 0.01 | 0.01 | 0.01 | 0.01 |
| ODTESPC³ | — | — | — | 2.2 | 2.2 |
| PHMBG⁴ | 1.3 | 1.3 | 1.3 | 1.3 | 1.3 |
| Silk Protein | 0.01 | 0.01 | — | 0.01 | 0.01 |
| Caprylyl Glucosicde | 0.75 | 1.0 | 1.5 | 1.0 | 1.0 |
| Laureth-4 | 0.50 | 0.50 | 0.75 | 0.5 | 0.5 |
| C₁₂/C₁₅ Pareth12 | — | — | — | — | — |
| Bzk Usp Nf 50% | 0.26 | 0.26 | 0.26 | 0.26 | 0.26 |
| Lauramine | — | — | — | — | 0.001 |
| Citric Acid | | | | | |
| Aloe Vera B Le⁵ | 0.05 | 0.05 | 0.05 | 0.05 | 0.05 |
| Vit E Acetate | — | — | — | — | — |
| Hyaluronic Acid | — | — | 0.001 | — | — |
| Phenoxyethanol | — | — | 0.01 | 0.01 | 0.01 |
| Methyl Paraben | 0.01 | 0.01 | — | — | — |
| Fragrance | — | — | — | — | — |
| Blue No 1 | — | — | — | — | — |

¹1-Octadecanaminium, N,N, Dimethyl-N-[(3-trimethoxysilyl) propyl] chloride = ODTMSPC
²1-Octadecanaminium, N,N, Dimethyl-N-[(3-trihydroxysilyl) propyl] chloride polymer = ODTHSPCP
³1-Octadecanaminium, N,N, Dimethyl-N-[(3-triethoxysilyl) propyl] chloride = ODTESPC
⁴Polymeric biguanide HCL
⁵Aloe Barbadensis Leaf Extract

Several formulations were blended into DI water at 50 C with high shear mixing technology. As part A, the 1-Octadecanaminium, N, N, Dimethyl-N-[(3-trihydroxysilyl) propyl] chloride polymer (ODTHSPCP) was mixed into 85° C. DI water by itself under high shear mixing to dissolve the polymer prior to the Part B of other ingredients.

Part B: The addition of >2.2 wt % (>1.5 wt % active) 1-Octadecanaminium, N, N, Dimethyl-N-[(3-trimethoxysilyl) propyl] chloride (ODTMSPC) and 1-Octadecanaminium, N, N, Dimethyl-N-[(3-triethoxysilyl) propyl] chloride (ODTESPC) are added to 50° C. DI water with high shear mixing to dissolve and then requires additions of various surfactants for stable emulsions/dispersions. Compositions were subjected to hand feel and testing.

### Example 2

My Shield-Unscented Antimicrobial Liquid or Foam Formulation with Aloe Vera

Several formulations were compounded as prepared with the following components:

Table 2 below show the formulations of Example 2.

TABLE 2

| | Formula | Formula | Formula | Formula | Formula |
|---|---|---|---|---|---|
| | No. 1 | No. 2 | No. 3 | No. 4 | No. 5 |
| Chemical | Wt % | Wt % | Wt % | Wt % | Wt % |
| DI Water | 94.938 | 94.688 | 94.677 | 94.673 | 93.868 |
| ODTMSPC¹ | — | — | — | — | — |
| ODTHSPCP² | 0.001 | 0.001 | — | — | — |
| ODTESPC³ | 2.2 | 2.2 | 2.2 | 2.2 | 3.0 |
| PHMBG⁴ | 1.3 | 1.3 | 1.3 | 1.3 | 1.3 |
| Silk Protein | 0.001 | 0.001 | 0.001 | 0.001 | 0.001 |
| Caprylyl Glucosicde | 1.0 | 1.0 | 1.0 | 1.0 | 1.0 |
| Laureth-4 | — | — | — | — | — |
| Polyol 4290 | 0.25 | 0.50 | 0.50 | 0.50 | 0.50 |
| Bzk Usp Nf 50% | 0.26 | 0.26 | 0.26 | 0.26 | 0.26 |
| Lauramine | — | — | 0.001 | 0.001 | 0.01 |
| Citric Acid | | | | | |
| Aloe Vera B Le⁵ | 0.05 | 0.05 | 0.05 | 0.05 | 0.05 |
| Vit E Acetate | — | — | — | — | 0.001 |
| Hyaluronic Acid | — | — | — | 0.005 | — |
| Phenoxyethanol | 0.01 | 0.01 | 0.01 | 0.01 | 0.01 |
| Methyl Paraben | — | — | — | — | — |
| Clay | — | — | 0.001 | — | — |
| Blue No 1 | — | — | — | — | — |

¹1-Octadecanaminium, N,N, Dimethyl-N-[(3-trimethoxysilyl) propyl] chloride = ODTMSPC
²1-Octadecanaminium, N,N, Dimethyl-N-[(3-trihydroxysilyl) propyl] chloride polymer = ODTHSPCP
³1-Octadecanaminium, N,N, Dimethyl-N-[(3-triethoxysilyl) propyl] chloride = ODTESPC
⁴Polymeric biguanide HCl = PHMBG
⁵Aloe Barbadensis Leaf Extract

Several formulations were blended into DI water at 50° C. with high shear mixing technology. As part A, the 1-Octadecanaminium, N, N, Dimethyl-N-[(3-trihydroxysilyl) propyl] chloride polymer (ODTHSPCP) was mixed into 85° C. DI water by itself under high shear mixing to dissolve the polymer prior to the Part B of other ingredients.

Part B: The addition of >2.2 wt % (>1.5 wt % active) 1-Octadecanaminium, N, N, Dimethyl-N-[(3-trimethoxysilyl) propyl] chloride (ODTMSPC) and 1-Octadecanaminium, N, N, Dimethyl-N-[(3-triethoxysilyl) propyl] chloride (ODTESPC) are added to 50 C DI water with high shear mixing to dissolve and then requires additions of various surfactants for stable emulsions/dispersions. Compositions were subjected to hand feel and microbial laboratory testing.

### Example 3

My shield—Unscented Antimicrobial Gel Formulation with Aloe Vera

Several formulations as shown in Table 3 were compounded as prepared with the following components:

TABLE 3

| | Formula | Formula | Formula | Formula | Formula |
|---|---|---|---|---|---|
| | No. 1 | No. 2 | No. 3 | No. 4 | No. 5 |
| CHEMICAL | Wt % | Wt % | Wt % | Wt % | Wt % |
| DI Water | 95.179 | 94.679 | 94.179 | 94.129 | 94.129 |
| Hydroxyethylcellulose | 0.5 | 1.0 | 1.50 | 1.55 | 1.55 |
| ODTMSPC¹ | 2.2 | 2.2 | 2.2 | 2.2 | — |
| ODTHSPCP² | — | — | — | — | — |
| ODTESPC³ | — | — | — | — | 2.2 |
| PHMBG⁴ | 1.3 | 1.3 | 1.3 | 1.3 | 1.3 |
| Silk Protein | 0.001 | 0.001 | 0.001 | 0.001 | 0.001 |
| Caprylyl Glucosicde | 0.3 | 0.3 | 0.3 | 0.3 | 0.3 |
| Laureth-4 | 0.2 | 0.2 | 0.2 | 0.2 | 0.2 |
| C₁₂/C₁₅ Pareth12 | — | — | — | — | — |
| Bzk Usp Nf 50% | 0.26 | 0.26 | 0.26 | 0.26 | 0.26 |
| Polyol 4290 | — | — | — | — | — |
| Lauramine | — | — | — | — | — |
| Citric Acid | — | — | — | — | — |
| Aloe Barbadensis Le⁵ | 0.05 | 0.05 | 0.05 | 0.05 | 0.05 |
| Vit E Acetate | — | — | — | — | — |
| Hyaluronic Acid | — | — | — | — | — |
| Phenoxyethanol | — | 0.010 | 0.01 | 0.01 | 0.01 |
| Methyl Paraben | 0.01 | — | — | — | — |
| Fragrance | — | — | — | — | — |
| Blue No. 1 | — | — | — | — | — |

¹Ex1-Octadecanaminium, N,N, Dimethyl-N-[(3-trimethoxysilyl) propyl] chloride = ODTMSPC
²1-Octadecanaminium, N,N, Dimethyl-N-[(3-trihydroxysilyl) propyl] chloride polymer = ODTHSPCP
³1-Octadecanaminium, N,N, Dimethyl-N-[(3-triethoxysilyl) propyl] chloride = ODTESPC
⁴Polymeric biguanide HCL = PHMBG
⁵Aloe Barbadensis Leaf Extract

Several formulations were blended into DI water at 50° C. with high shear mixing technology.

As part A, the Hydroxyethyl cellulose was mixed into 85° C. DI water by itself under high shear mixing to dissolve the gel prior to the Part B of other ingredients.

Part B: The addition of >2.2 wt % (>1.5 wt % active) 1-Octadecanaminium, N, N, Dimethyl-N-[(3-trimethoxysilyl) propyl] chloride (ODTMSPC) and 1-Octadecanaminium, N, N, Dimethyl-N-[(3-triethoxysilyl) propyl] chloride (ODTESPC) are added to 50° C. DI water with high shear mixing to dissolve and then requires additions of various surfactants for stable emulsions/dispersions. Part A was added to Part B with the components already mixed by a special reactor with side sweep agitation, circulation pump and high shear rotor stator agitator at 50° C. Compositions were subjected to hand feel and microbial laboratory testing.

### Example 4

My Shield-Scented Antimicrobial Liquid or Foam Formulation with Aloe Vera

Several formulations were compounded as prepared with the following components as shown in Table 4 below:

TABLE 4

| | Formula | Formula | Formula | Formula | Formula |
|---|---|---|---|---|---|
| | No. 1 | No. 2 | No. 3 | No. 4 | No. 5 |
| Chemical | Wt % | Wt % | Wt % | Wt % | Wt % |
| DI Water | 95.117 | 95.117 | 94.668 | 95.118 | 93.869 |
| ODTMSPC¹ | — | — | — | — | — |
| ODTHSPCP² | 0.001 | 0.001 | 0.001 | 0.001 | — |
| ODTESPC³ | 2.2 | 2.2 | 2.2 | 2.2 | 3.0 |
| PHMBG⁴ | 1.3 | 1.3 | 1.3 | 1.3 | 1.3 |
| Silk Protein | 0.001 | 0.001 | 0.001 | 0.001 | 0.001 |
| Caprylyl Glucosicde | 0.5 | 0.5 | 1.0 | 0.05 | 1.0 |
| Laureth-4 | | | | | |
| Polyol 4290⁶ | 1.0 | 1.0 | 0.5 | 1.0 | 0.5 |
| Bzk Usp Nf 50% | 0.26 | 0.26 | 0.26 | 0.26 | 0.26 |
| Lauramine | 0.001 | | | | |
| Citric Acid | | | | | |
| Aloe Vera B Le³ | 0.05 | 0.05 | 0.05 | 0.05 | 0.05 |
| Vit E Acetate | | 0.001 | | | |
| Hyaluronic Acid | | | | | |
| Phenoxyethanol | 0.01 | 0.01 | 0.01 | 0.01 | 0.01 |
| Tea Tree Oil | 0.01 | 0.01 | | | 0.01 |
| Lemon Eucalyptus | | | 0.01 | 0.01 | |

¹1-Octadecanaminium, N,N, Dimethyl-N-[(3-trimethoxysilyl) propyl] chloride = ODTMSPC
²1-Octadecanaminium, N,N, Dimethyl-N-[(3-trihydroxysilyl) propyl] chloride polymer = ODTHSPCP
³1-Octadecanaminium, N,N, Dimethyl-N-[(3-triethoxysilyl) propyl] chloride = ODTESPC
⁴Polymeric biguanide HCL = PHMBG
⁵Aloe Barbadensis Leaf Extract
⁶POLYOL 4290 = Pentaerythritol Ethoxylate

Several formulations were blended into DI water at 50° C. with high shear mixing technology. As part A, the 1-Octadecanaminium, N, N, Dimethyl-N-[(3-trihydroxysilyl) propyl] chloride polymer (ODTHSPCP) was mixed into 85° C. DI water by itself under high shear mixing to dissolve the polymer prior to the Part B of other ingredients.

Part B: The addition of >2.2 wt % (>1.5 wt % active) 1-Octadecanaminium, N, N, Dimethyl-N-[(3-trimethoxysilyl) propyl] chloride (ODTMSPC) and 1-Octadecanaminium, N, N, Dimethyl-N-[(3-triethoxysilyl) propyl] chloride (ODTESPC) are added to 50° C. DI water with high shear mixing to dissolve and then requires additions of various surfactants for stable emulsions/dispersions. Compositions were subjected to hand feel and microbial laboratory testing.

### Example 5

### My Shield Sanitizing Bath Wipe, Hand Wipe, PreOp Wipe Formulation, Construction and Fabrication

In several test runs at American Flexpack, Green Bay Wis., using Sontara Style 8005 Non-woven Polyester Fabric 67 gms/m² with wet pick up of 670%, wipes of two sizes were made to include 38.1 cm×30 cm and 20 cm×20 cm.

A test for various liquid wet pickup targets and hand feel is listed in Table 5.

TABLE 5

| WIPE DIMENSIONS CM | LIQUID AMOUNT GM | HAND FEEL |
|---|---|---|
| 38.1 × 30 | 100 GM | PASS |
| 38.1 × 30 | 50 GM | PASS |
| 38.1 × 30 | 20 GM | PASS |
| 20 × 20 | 30 GM | PASS |
| 20 × 20 | 20 GM | PASS |
| 20 × 20 | 12 GM | PASS |

The wipes were packaged in Sterilized Polypropylene micro waivable film packet.

### Example 6

### My Shield Foam Formula No. 4 of Example 1 Table 1

Technical Standard for Disinfection (2002 Ministry of Health P.R. China)-2.1.1.7.4 Suspension Quantitative Germicidal Test by Guangdong Detection Center of Microbiology.

TABLE 6

| | | | CFU of | | CFU in | | |
|---|---|---|---|---|---|---|---|
| Sample | | Test | bacteria | CFU Average | test | | |
| and time | Tested organism | number | control | in control | sample | Log kill | Kill rate % |
| My-shield | E coli | 1 | 3.0 × 10⁷ | 3.3 × 10⁷ | <10 | >5.00 | >99.999 |
| Formula | ATCC 8099 | | | | | | |
| Ex 1 | E coli | 2 | 3.3 × 10⁷ | | <10 | >5.00 | >99.999 |
| At 10 min | ATCC 8099 | | | | | | |
| | E coli | 3 | 3.5 × 10⁷ | | <10 | >5.00 | >99.999 |
| | ATCC 8099 | | | | | | |
| My shield | Staphylococcus | 1 | 4.2 × 10⁷ | 4.2 × 10⁷ | <10 | >5.00 | >99.999 |
| Formula | aureus ATCC | | | | | | |
| of Ex 1 | 6538 | | | | | | |
| At 10 min | Staphylococcus | 2 | 3.9 × 10⁷ | | <10 | >5.00 | >99.999 |
| | aureus ATCC | | | | | | |
| | 6538 | | | | | | |
| | Staphylococcus | 3 | 4.5 × 10⁷ | | <10 | >5.00 | >99.999 |
| | aureus ATCC | | | | | | |
| | 6538 | | | | | | |

Conclusion: All of the test results can meet the standards and the neutralizer being tested was qualified.

### Example 7

### My Shield Gel Formula Table 3 Formula No. 1

Technical Standard for Disinfection (2002 Ministry of Health P.R. China)-2.1.1.7.4 Suspension Quantitative Germicidal Test by Guangdong Detection Center of Microbiology.

TABLE 7

| | | | CFU of | | CFU in | | |
|---|---|---|---|---|---|---|---|
| Sample | | Test | bacteria | CFU Average | test | | |
| and time | Tested organism | number | control | in control | sample | Log kill | Kill rate % |
| My-shield | E coli | 1 | 3.0 × 10⁷ | 3.4 × 10⁷ | <10 | >5.00 | >99.999 |
| Formula | ATCC 8099 | | | | | | |
| Ex 1 | E coli | 2 | 3.3 × 10⁷ | | <10 | >5.00 | >99.999 |
| At 10 min | ATCC 8099 | | | | | | |
| | E coli | 3 | 3.6 × 10⁷ | | <10 | >5.00 | >99.999 |
| | ATCC 8099 | | | | | | |
| My shield | Staphylococcus | 1 | 4.2 × 10⁷ | 4.3 × 10⁷ | <10 | >5.00 | >99.999 |
| Formula | aureus ATCC | | | | | | |
| of Ex 1 | 6538 | | | | | | |
| At 10 min | Staphylococcus | 2 | 4.0 × 10⁷ | | <10 | >5.00 | >99.999 |
| | aureus ATCC | | | | | | |
| | 6538 | | | | | | |
| | Staphylococcus | 3 | 4.5 × 10⁷ | | <10 | >5.00 | >99.999 |
| | aureus ATCC | | | | | | |
| | 6538 | | | | | | |

Conclusion: All of the test results can meet the standards and the neutralizer being tested was qualified.

### Example 8

### My Shield Gel Formula of Table 3 Formula No. 1

Assessment of Antimicrobial Activity Using a Time Kill Procedure ASTM E2315-16 Against Burkholderia cepacia ATCC 25416

TABLE 8

| | | | Exposure | Test | | CFU/mL | Log | % |
|---|---|---|---|---|---|---|---|---|
| Lab No | Sample ID | Lot # | time | samples | CFU/ml | average | Reduction | Reduction |
| | Control | | 0 min | 1 | 1.10 × 10⁸ | 1.06 × 10⁸ | — | — |
| | | | | 2 | 1.02 × 10⁸ | | | |
| 129332 | My Shield | 38L17 | 2 min | 1 | 6.2 × 10⁶ | 6.4 × 10⁶ | 1.22 | 93.96 |
| | Hand | Ex Jan | | 2 | 6.6 × 10⁶ | | | |
| | Sanitizer | 09/19 | 5 min | 1 | 2.8 × 10⁶ | 3.4 × 10⁶ | 1.49 | 96.79 |
| | | | | 2 | 4.0 × 10⁶ | | | |
| | | | 10 min | 1 | 4.4 × 10⁴ | 4.8 × 10⁴ | 3.34 | 99.95 |
| | | | | 2 | 5.2 × 10⁴ | | | |

Conclusion: Hand Sanitizer Lot 38L17 showed 93.96% anti-microbial activity against B cepacia at 2 min, 96.79% at 5 min. and 99.95% at 10 min, contact time against Burkholderia cepacia ATCC 25416.

### Example 9

### My Shield Topical Antiseptic Formula of Table 3 Formula No 1

Assessment of Antimicrobial Activity Using a Time Kill Procedure ASTM E2315-16 Against Burkholderia cepacia ATCC 25416

TABLE 9

| | Sample | | Exposure | | | CFU/ml | | % |
|---|---|---|---|---|---|---|---|---|
| Lab No | ID | Lot # | time | Reps | CFU/ml | average | Log Kill | Reduction |
| — | control | — | 0 hours | 1 | 4.4 × 10⁸ | 4.8 × 10⁸ | — | — |
| | | | | 2 | 5.2 × 10⁸ | | | |
| 128906 | Myshield | 09K17 | 15 sec | 1 | 8.8 × 10⁶ | 8.5 × 10⁶ | 1.75 | 98.23 |
| | Topical | | | 2 | 8.2 × 10⁶ | | | |
| | Anti | | 30 sec | 1 | 6.0 × 10⁶ | 5.9 × 10⁶ | 1.91 | 98.77 |
| | Septic | | | 2 | 5.8 × 10⁶ | | | |
| | | | 60 sec | 1 | 3.5 × 10⁶ | 4.0 × 10⁶ | 2.08 | 99.16 |
| | | | | 2 | 4.5 × 10⁶ | | | |

Conclusion: My Shield Topical Antiseptic Lot 09K17 showed 98.23% anti-microbial activity against B cepacia at 15 seconds of contact time, 98.77% at 30 seconds and 99.16% at 60 seconds.

### Example 10

### My Shield Topical Antiseptic Formula Table 3 Formula No. 1 ASTM E2197-11

Evaluation for Clostridium difficile spores ATCC 43598

TABLE 10

| | Mean Log₁₀ | Density of | Control | Carrier 7.2M |
|---|---|---|---|---|
| | CFU/membrane | Log₁₀ | Mean Log₁₀ | Mean Log₁₀ |
| Carrier no | Post Exposure | CFU/Carrier | Density MT | Reduction |
| 1 | >200 | >2.3010 | >2.3010 | <4.9237 |
| 2 | >200 | >2.3010 | | |
| 3 | >200 | >2.3010 | | |
| 4 | >200 | >2.3010 | | |
| 5 | >200 | >2.3010 | | |

### Test Substance Preparation: Ready to use

Test Organism: Clostridium difficile—spore form (ATCC 43598)
Exposure temperature: Room temperature (21° C.)
Exposure time: 10 minutes
# of carriers tested: 5 test carriers and 3 control carriers
Soil Load: No soil load required
Test Carrier plating: Entire contents of 10⁰ (vial) only.

### Neutralizer: PBS 4+0.14% Lecithin+1.0% Tweet 80

### Carrier Quantitation Control:

2.45×10⁶ (6.39 Log₁₀) CFU/carrier (PASS)

### Test Results:

Average survivors: >2.00×10² (>2.30 Log₁₀) CFU/carrier

### =<99.998% (<4.9237 Log₁₀) Reduction

### Example 11

### Film Thickness of ODTMSPC

Test on thickness of skin scaffold of monomer 1-Octadecanaminium N, N Dimethyl [(3-trimethoxysilyl)propyl]chloride with Dual Polarization Interferometry

TABLE 11

| | | | |
|---|---|---|---|
| TIME POST | THICKNESS | REFRACTIVE | MASS |
| INJECTION | nm | INDEX | ngmm⁻² |

| | | | | |
|---|---|---|---|---|
| 40 | seconds | 41.31 | 1.3496 | 3.83 |
| 10 | minutes | 33.51 | 1.3534 | 3.76 |

### Example 12

### Film Thickness of ODTMSPCP

Film thickness of skin scaffold of polymer 1-Octadecanaminium NN Dimethyl (3 Trihydroxysilyl)propyl chloride polymer with Dual Polarization interferometry.

TABLE 12

| | | | |
|---|---|---|---|
| TIME POST | THICKNESS | REFRACTIVE | MASS |
| INJECTION | nm | INDEX | ngmm⁻² |

| | | | | |
|---|---|---|---|---|
| 40 | seconds | 1.85 | 1.4612 | 1.341 |
| 10 | minutes | 0.84 | 1.4891 | 0.683 |

### Example 13

### Bacillus Spore Effects of Hand Sanitizer Addition in Plate

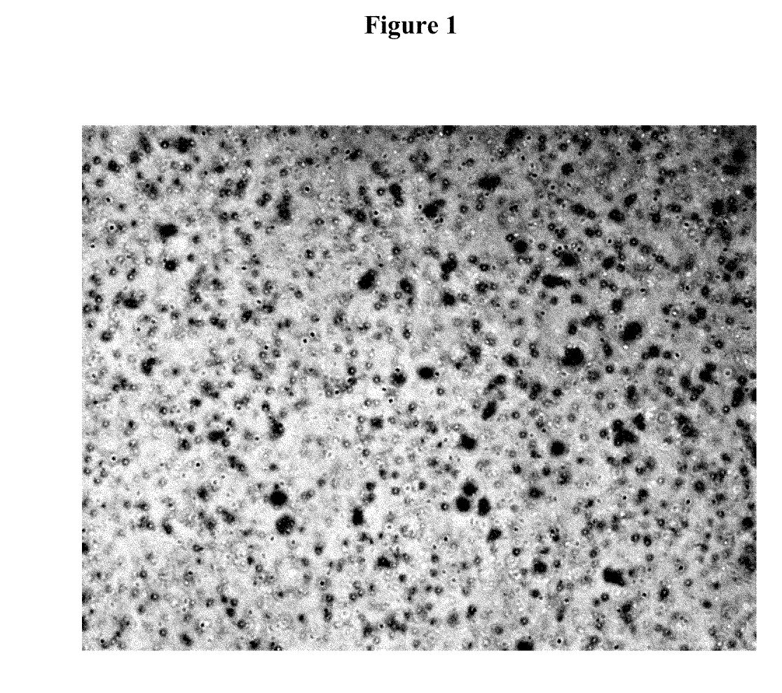

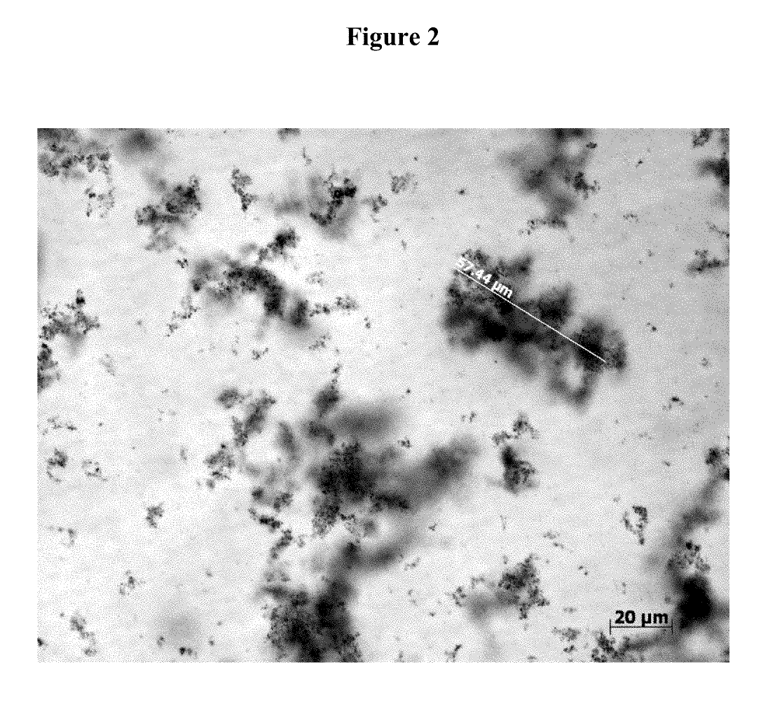

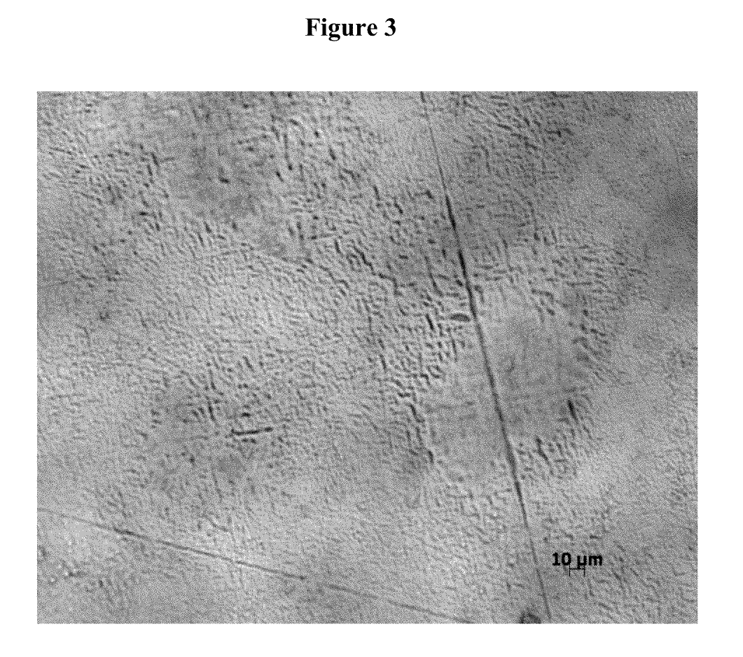

In this experiment live Bacillus spores in a plate too many to count (TMTC) were photographed by a Zeiss microscope as shown in FIG. 1. The plate in FIG. 2 had the addition of my Shield Hand Sanitizer Foam Table 1 Formula No. 2 added to the plate 20 ml. The cationic formulation agglomerated the spores into groupings. In FIG. 3 the Hand Sanitizer dried and film formed over the spores encapsulating the spores.

### Example 14

Efficacy of Rub on Middle Eastern Respiratory Syndrome (MERS) Surrogate Virus on Human Skin. Hand Sanitizer Table 1 Formula No 2

Arizona State University Test on humans (skin) with hand rub against MERS 3 ml of hand sanitizer rubbed on hands, dried and tested after 5 minutes residence time.

Results: my-shield Hand Sanitizer was able to achieve a >99.9% (>3.19 log 10) reduction. All replicates in the presence my-shield Hand Sanitizer Foam were below the limit of detection for the assay suggesting that greater reductions are achievable. Results are shown in Table 13.

TABLE 13
My-shield Hand Sanitizer Test Using Four Human Subjects
Against Feline Infectious Peritonitis Virus (FIPV)

| | PRE | POST | | |
|---|---|---|---|---|
| | EXPOSURE | EXPOSURE | LOG 10 | PERCENT |
| SAMPLE | VIRAL TITER | VIRAL TITER | REDUC- | REDUC- |
| ID | LOG 10/ML | LOG 10 PER mL | TION | TION |
| Human | 6.0 | <2.50 | >3.50 | 99.97% |
| Subject 1 | | | | |
| Human | 5.75 | <2.50 | >3.25 | 99.94% |
| Subject 2 | | | | |
| Human | 5 | <2.50 | >2.50 | 99.7% |
| Subject 3 | | | | |
| Human | 5 | <2.50 | >3.50 | 99.97% |
| Subject 4 | | | | |
| Average | 6 | <2.50 | >3.19 | 99.9% |

Conclusions: Detection Limit = ≤2.50 log10 per ml my-shield Hand Sanitizer Foam is effective at reducing feline infectious peritonitis

The contents of all references cited in the instant specifications and all cited references in each of those references are incorporated in their entirety by reference herein as if those references were denoted in the text.

While the many embodiments of the invention have been disclosed above and include presently preferred embodiments, many other embodiments and variations are possible within the scope of the present disclosure and in the appended claims that follow. Accordingly, the details of the preferred embodiments and examples provided are not to be construed as limiting. It is to be understood that the terms used herein are merely descriptive rather than limiting and that various changes, numerous equivalents may be made without departing from the spirit or scope of the claimed invention.

What is claimed is:

1. A composition for use on mammals as a topical antiseptic rub, said composition comprising:
(a) a polymeric skin scaffold selected from the group consisting of: polymers of 1-Octadecanaminium N,N dimethyl [(3-trihdroxysilyl) propyl] chloride, silk protein, polyhexanide and mixtures thereof said skin scaffold further including a monomeric coupling agent selected from the group consisting of of alkyl dialkylammonium trimethoxysilylpropyl chloride;
(b) an antimicrobial active selected from the group consisting of alkyldimethylbenzylammonium chloride of the formula 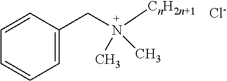
where n=8, 10, 12, 14, 16, 18;
(c) a carrier for the polymers consisting of pharmaceutical grade water and surfactants selected from the group consisting of non-ionics, anionic, cationic, amphoteric and switterionic surfactants said surfactants also being suitable for emulsification of the composition; and
(d) a clay stabilizer for the trimethoxysilyl functional group.

2. The composition of claim 1, further comprising a skin moisturizer selected from the group consisting of: Aloe Vera, Vitamin E acetate and mixtures thereof.

3. The composition of claim 1, further comprising an amino acid selected from the group consisting of: arginine, allantoin, L-alanine and mixtures thereof.

4. The composition of claim 1, further comprising an extracellular matrix comprising hyaluronic acid and sodium salts thereof.

5. The composition of claim 1, optionally containing additional components selected from the group consisting of a citric acid buffer, a fragrance, UVA and UVB absorbers, UV luminescent dyes for detection under a black light monitor, viscosity modifiers selected from the group consisting of hydroxyethyl cellulose, xanthan gum or modifiers to make a sol gel and mixtures thereof.

6. The composition of claim 1, wherein the polymeric skin scaffold forms a clear film of about 20-50 nm thickness which is plasticized with other components to form a flexible and lasting film.

7. The composition of claim 1, wherein said composition is applied in effective amounts to agglomerate and kill spores.

8. The composition of claim 1, wherein said composition dries in 30-120 seconds and displays activity against bacteria, virus, fungi, spores on human skin in about 15 seconds to about 10 minutes.

9. The composition of claim 1, wherein said composition improves skin softness and retains skin moisture on males and females having aged skin of about >50 years.

10. The composition of claim 1, wherein said composition reduces the skin flux of the benzalkonium chloride.

11. The composition of claim 1, wherein said composition extends the protection of the person treated with the topical antiseptic in hours as compared to minutes with alcohol.

12. The composition of claim 1, wherein said composition reduces patient to health care worker transfer of pathogens.

13. The composition of claim 1, wherein said composition reduces human bacterial generated odor and can be used as an odor masking agent.

14. The composition of claim 1, wherein said composition reduces skin irritation due to benzalkonium chloride and can be used in larger concentrations.

15. A composition for use on mammals as a topical antiseptic rub, said composition comprising:
(a) a polymeric skin scaffold selected from the group consisting of: polymers of 1-Octadecanaminium N,N dimethyl [(3-trihdroxysilyl) propyl] chloride, silk protein, polyhexanide and mixtures thereof said skin scaffold further including a monomeric coupling agent selected from the group consisting of of alkyl dialkylammonium trimethoxysilyl propyl chloride; and
(b) an extracellular matrix comprising hyaluronic acid and sodium salts thereof.

16. The composition of claim 15, further comprising an antimicrobial active selected from the group consisting of alkyldimethylbenzylammonium chloride of the formula 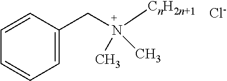
where n=8, 10, 12, 14, 16, 18 and mixtures thereof.

17. The composition of claim 15, further comprising a carrier for the polymers consisting of pharmaceutical grade water and surfactants selected from the group consisting of non-ionics, anionic, cationic, amphoteric and switterionic surfactants said surfactants also being suitable for emulsification of the composition.

18. The composition of claim 15, further comprising an amino acid selected from the group consisting of: arginine, allantoin, L-alanine and mixtures thereof.

19. The composition of claim 15, further comprising an extracellular matrix comprising hyaluronic acid and sodium salts thereof.

20. The composition of claim 15, optionally containing additional components selected from the group consisting of a citric acid buffer, a fragrance, UVA and UVB absorbers, UV luminescent dyes for detection under a black light monitor, viscosity modifiers selected from the group consisting of hydroxyethyl cellulose, xanthan gum or modifiers to make a sol gel and mixtures thereof.
